(19) United States
(12) Patent Application Publication
(10) Pub. No.: US 2015/0352921 A1
(43) Pub. Date: Dec. 10, 2015

(54) RIDE HEIGHT ADJUSTABLE AGRICULTURAL VEHICLE WITH IMPROVED SUSPENSION

(71) Applicant: Matthew W. Dames, Clarion, IA (US)

(72) Inventor: Matthew W. Dames, Clarion, IA (US)

(21) Appl. No.: 14/736,877

(22) Filed: Jun. 11, 2015

Related U.S. Application Data
(63) Continuation-in-part of application No. 14/248,682, filed on Apr. 9, 2014.

(51) Int. Cl. B60G 17/08; B60G 11/27

(52) U.S. Cl. CPC B60G 17/08; B60G 11/27

(57) ABSTRACT

A system and method for providing suspension for a ride height adjustable vehicle. The vehicle has a four-bar linkage assembly coupled between to the frame and wheel of the vehicle. A linear actuator coupled to the four-bar linkage assembly raises and lowers the ride height of the vehicle. An airbag is also coupled to one of the linkages to provide suspension. The airbag and linear actuator are coupled to one another by a pivotable plate. The airbag and linear actuator co-act to provide suspension for the vehicle across all ride heights.

### TECHNICAL FIELD

The disclosed embodiments relate in general to a ride height adjustable vehicle and, more specifically, to a ride height adjustable vehicle with improved suspension.

### BACKGROUND OF THE INVENTION

Ride height adjustment systems for agricultural sprayers are known in the art. Some such systems have an outer journal provided with an inner leg that rotates relative to the outer journal. In addition to the ride height adjustment, it is also desirable to include a cushioning system to add to driver comfort when operating the agricultural sprayer. A cushioned ride height adjustment system is shown in U.S. Pat. No. 5,597,172.

Prior art suspensions, however, use a large number of large parts, which not only increase the cost and weight of the suspension system, but also the maintenance costs as well. An additional drawback of such prior art suspension systems is that they require a large unobstructed area for proper operation. Prior art suspension systems often utilize a linear actuator coupled to the frame and a scissor assembly that extends beyond the frame of the suspension system. These assemblies require a large unobstructed area that limits their application on more compact agricultural sprayers. It would therefore be desirable to provide a more compact steering assembly, incorporating fewer, more easily maintained, parts.

Some prior art ride height adjustment systems for agricultural sprayers have limited amount of travel. Systems with a transaxle parallel linkage oriented perpendicular to the frame, or vertical cylinders are often limited to a travel of about eighteen inches or less where prior art suspension systems can provide needed suspension. Such prior art systems however are often not as suited to vehicles with larger amounts of ride height adjustment, as they can require too much space for their operation, compromising vehicle crop clearance and/or being susceptible to large bending moments as in the case of a vertical cylinder.

It would therefore be desirable to provide a vehicle with a large amount of ride height travel without compromising vehicle crop clearance, and that allows for 4-wheel independent suspension. It would also be desirable to decouple the steering system from the suspension, thus eliminating complicated linkage systems in the steering system. Decoupling the steering system from the suspension allows automatic steering systems to function without having to take in additional tolerances and clearances to account for complex steering linkages. The difficulties discussed hereinabove are sought to be eliminated by the present invention.

### SUMMARY OF THE DISCLOSED SUBJECT MATTER

The present invention includes systems and methods for an improved suspension used in association with systems for raising and lowering the height of a vehicle. The system uses a four-bar linkage assembly coupled to the frame of a vehicle. An airbag is coupled to one of the linkages, while a linear actuator is coupled to another of the linkages. The airbag and linear actuator are coupled to one another by a pivotable plate. The airbag and linear actuator co-act to provide suspension for the vehicle. In addition to providing suspension, the linear actuator also actuates the four-bar linkage assembly to raise and lower the ride height of the vehicle.

The features and advantages described in this summary and the following detailed description are not all-inclusive. Many additional features and advantages may be apparent to one of ordinary skill in the art in view of the drawings, specification and claims presented herein.

### BRIEF DESCRIPTION OF THE DRAWINGS

FIG. 1 illustrates a side elevation of the vehicle shown with the vehicle in the lifted position in accordance with one embodiment;

FIG. 2 illustrates the vehicle of FIG. 1 shown with the vehicle in the lowered position;

FIG. 3 illustrates a front perspective view of the height adjustment assembly in accordance with one embodiment;

FIG. 4 illustrates a top perspective view in partial cutaway of the height adjustment assembly of FIG. 3;

FIG. 5 illustrates a side elevation of a leveling linkage in accordance with one embodiment in the lowered position;

FIG. 6 illustrates a side elevation of a leveling linkage in accordance with one embodiment in the raised position;

FIG. 7 illustrates a front elevation of the rear of a height adjustment assembly in accordance with one embodiment;

FIG. 8 illustrates a side elevation of a lifting linkage in accordance with one embodiment in the lowered position;

FIG. 9 illustrates a side elevation of a lifting linkage in accordance with one embodiment in the raised position;

FIG. 10 illustrates a front elevation of a vehicle moving over sloped terrain in accordance with one embodiment.

FIG. 11 illustrates a side elevation of an alternative embodiment of the vehicle shown with the vehicle in the lifted position;

FIG. 12 illustrates the vehicle of FIG. 11, shown in the lowered position;

FIG. 13 illustrates a front perspective view of the height adjustment assembly of the vehicle of FIG. 11;

FIG. 14 illustrates a front perspective view of the height adjustment assembly of FIG. 13 shown from the interior;

FIG. 15 illustrates a top perspective view of the height adjustment assembly of FIG. 11;

FIG. 16 illustrates a front perspective view of the height adjustment assembly of the vehicle of FIG. 11, shown in the lowered position;

FIG. 17 illustrates a front perspective view of the height adjustment assembly of FIG. 13 shown from the interior, shown in the lowered position;

FIG. 18 illustrates a top perspective view of the height adjustment assembly of FIG. 11, shown in the lowered position.

FIG. 19 illustrates a front elevation of the vehicle of FIG. 11 moving over sloped terrain;

FIG. 20 illustrates a top perspective view in partial phantom of the toe adjust assembly of the vehicle of FIG. 11;

FIG. 21 illustrates a side perspective view in partial phantom of the toe adjust assembly of FIG. 11;

FIG. 22 illustrates a top perspective view of the toe assembly of FIG. 11 when the linkage assembly is angled toward the frame;

FIG. 23 illustrates a top perspective view of the toe adjustment assembly of FIG. 11 shown with the toe adjusted for when the linkage assembly is angled away from the frame;

FIG. 24 illustrates a top perspective view of the toe adjustment assembly of FIG. 11 shown with the linkage assembly angled away from the frame and the steering turned toward the right;

FIG. 25 illustrates a top perspective view of the toe adjust assembly of FIG. 11 shown with the linkage assembly angled away from the frame and the steering turned toward the left;

FIG. 26 illustrates a top elevation of the vehicle of FIG. 11 shown with the arms retracted; and

FIG. 27 illustrates a top elevation of the vehicle of FIG. 11 shown with the arms extended.

### DETAILED DESCRIPTION OF THE DRAWINGS

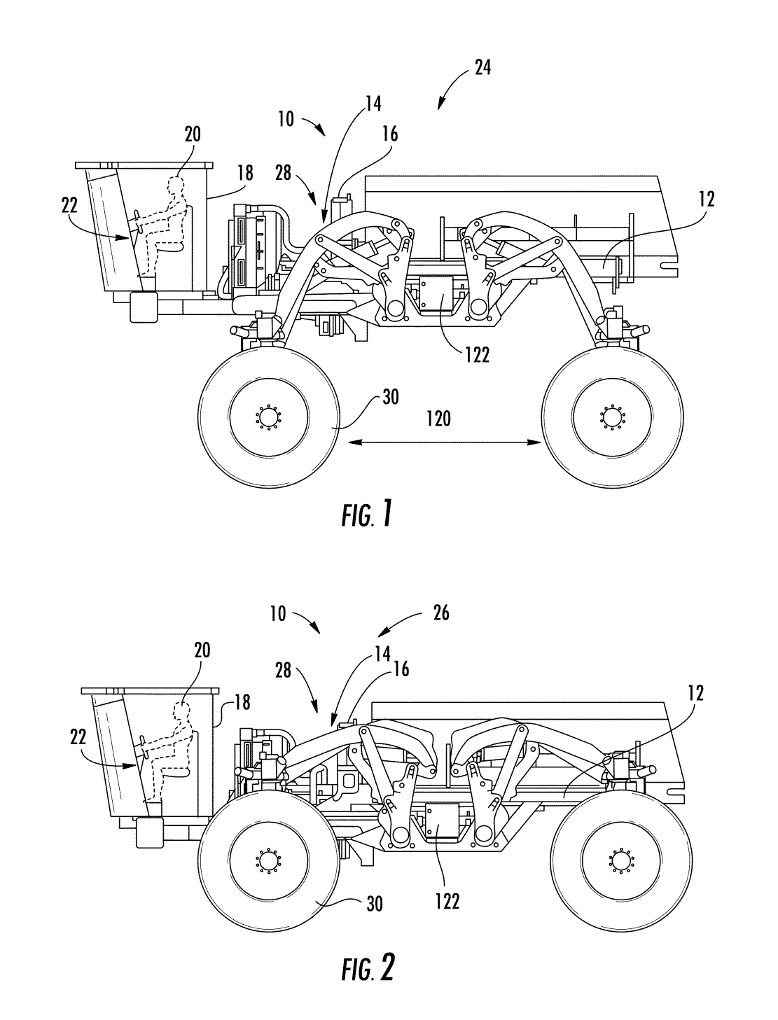

As shown in FIG. 1, a variable height vehicle (10) is provided with a frame (12). Coupled to the frame (12) are an engine (14), a hydraulic pump (16), and operator station (18). A user (20) controls the vehicle (10) from a control panel (22) located on the operator station (18). From the operator station (18), the user (20) may lower the vehicle (10) from the lifted orientation (24) shown in FIG. 1 to the lowered orientation (26) shown in FIG. 2.

The vehicle (10) is lifted and lowered by a plurality of closed chain linkages, which are preferably four-bar linkage assemblies (28). Separate four-bar linkage assemblies (28) are provided for each wheel (30) of the vehicle. As the four-bar linkage assemblies (28) are similar except for being mirror images of one another, description will be limited to a single four-bar linkage assembly (28).

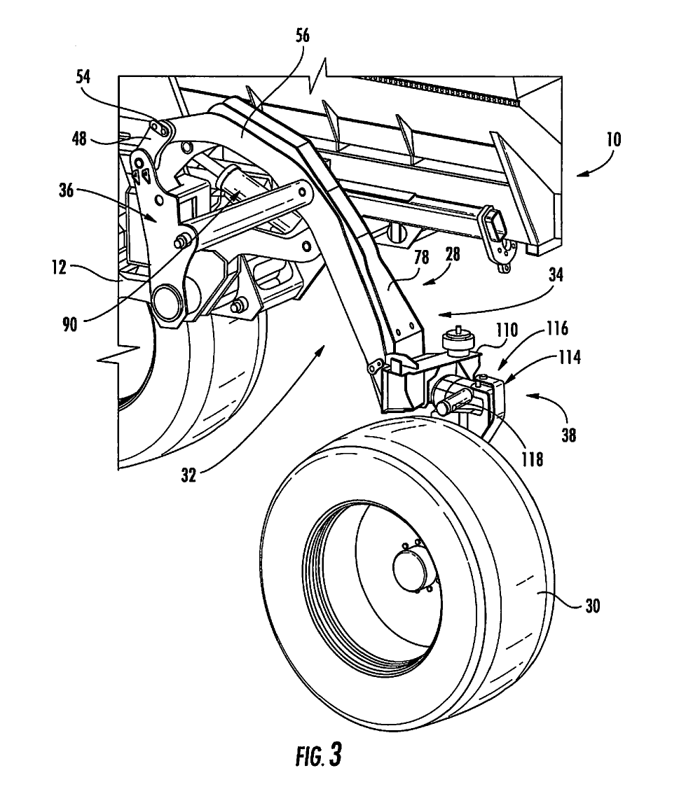

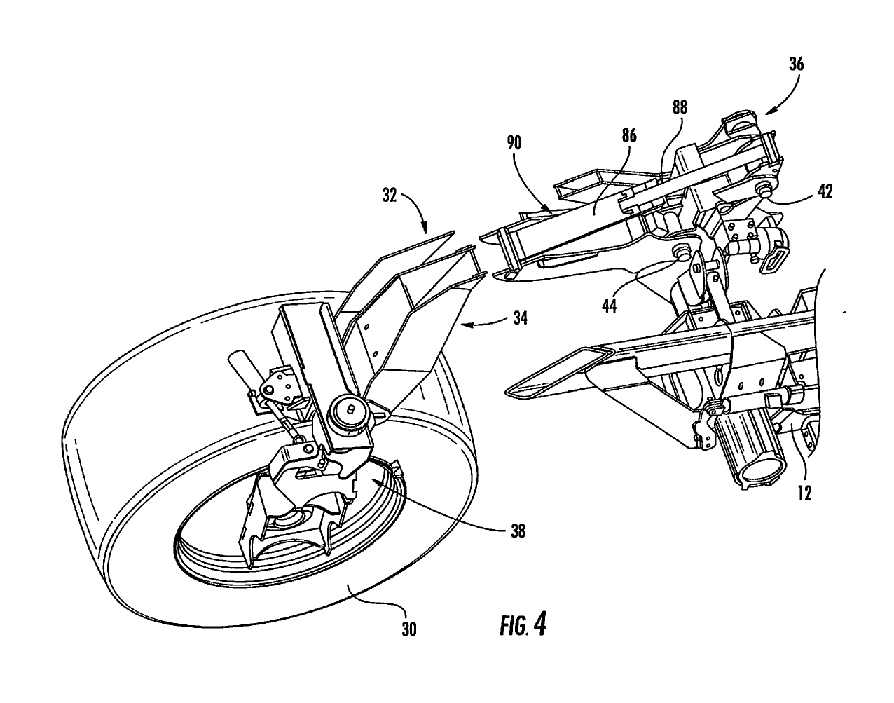

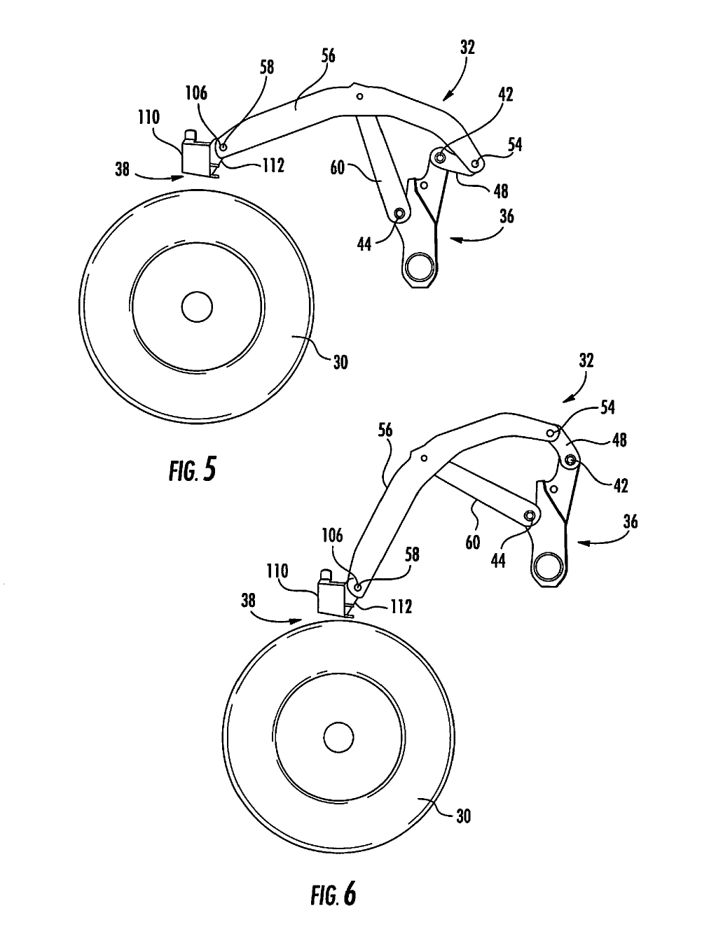

As shown in FIGS. 3-4, the four-bar linkage assembly (28) includes a first linkage assembly, otherwise known as the leveling linkage (32), and a second linkage assembly, otherwise known as the lifting linkage (34). Providing the other two components of the four-bar linkage assembly are a leg support structure (36) and a leg (38). The leg support structure (36) is secured to the frame (12) and the leg (38) is coupled to the wheel (30).

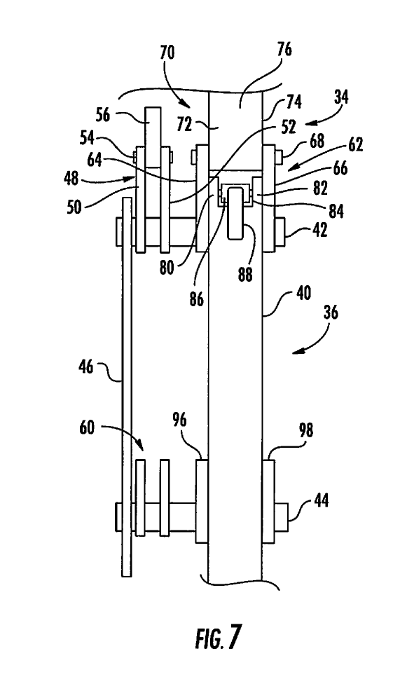

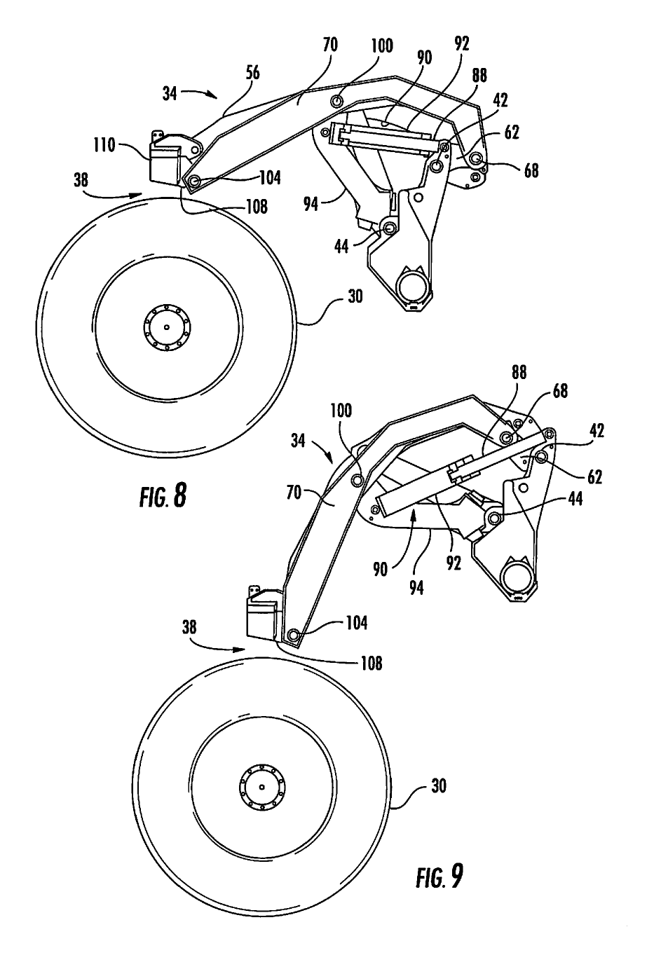

The leveling linkage (32) maintains the orientation of the leg (38) and wheel (30) as the vehicle (10) is raised and lowered by the lifting linkage (34). (FIGS. 1 and 5-6). The leveling linkage (32) also maintains the wheelbase and turning radius of the vehicle consistent as the vehicle (10) is raised and lowered. The leveling linkage (32) is pivotably coupled to the leg support structure (36). As shown in FIG. 7, the leg support structure (36) includes a main brace (40) secured to the frame (12). (FIGS. 1, 3, 4, and 7). Coupled to the main brace (40) by a pair of pins (42 and 44) is an outer plate (46). Pivotably secured to the upper pin (42) between the main brace (40) and the outer plate (46) is a first linkage (48) including a first plate (50) and second plate (52). The first linkage (48) is coupled, in turn, by a pin (54) to a second linkage (56) as shown in FIGS. 5-6, the second linkage (56) is a long curved steel plate provided with a hole (58) so that the second linkage (56) may be connected to the leg (38) via a steering knuckle (110). The second linkage (56) is pinned to the steering knuckle (110) and the steering knuckle (110) is secured to the leg (38). As shown in FIGS. 5-10, a third linkage (60) is pivotably coupled to the pin (44) between the main brace (40) and outer plate (46). The third linkage (60) is pivotably coupled on its opposite end to the second linkage (56) at a point between the first linkage (48) and the leg (38).

The lifting linkage (34) includes a fourth linkage (62) having a first plate (64) and second plate (66) pivotably secured to the pin (42) on opposite sides of the main brace (40). (FIGS. 3-5, and 7-10). The fourth linkage (62) is coupled in turn, by a pin (68) to a fifth linkage (70). The fifth linkage (70) may be of any desired design. In the preferred embodiment, the fifth linkage (70) has a pair of side plates (72 and 74) welded to a bottom plate (76) and a top plate (78). The fifth linkage (70) preferably tapers in width from the leg (38) toward the fourth linkage (62).

As shown in FIG. 7, the main brace (40) is provided with a pair of ears (80 and 82) to hold a pin (84). Provided around the pin (84) is a sleeve (86) coupled to a piston rod (88) of a linear actuator such as a hydraulic cylinder (90). (FIGS. 7-9). The cylinder barrel (92) of the hydraulic cylinder (90) is pivotably secured to a sixth linkage the sixth linkage (94) is a pair of plates (96 and 98) coupled around the pin (44) on either side of the main brace (40). The sixth linkage (94) is coupled on its other end to either side of the fifth linkage (70) via a pin (100) located between the ends of the fifth linkage (70). Unlike the third linkage (60), which is straight, the sixth linkage (94) is preferably provided with a curve (102) to allow for a longer hydraulic cylinder (90) to be located between the leg support structure (36) and sixth linkage (94). The hydraulic cylinder (90) is coupled to the hydraulic pumps (16) by means known in the art.

The four-bar linkage assembly (28) is coupled to the leg (38) by two pins (104 and 106) FIGS. 5-9. The first pin (104) is secured between two steel ears (108) welded to a steering knuckle (110). The pin (104) passes through the fifth linkage (70) that is provided between the ears (108). The other pin (106) is secured to another ear (112) welded to the steering knuckle (110). The second linkage (56) is secured to the steering knuckle (110) at a higher point than the fifth linkage (70) to allow the second linkage (56) and fifth linkage (70) to act as parallel linkages to raise and lower the vehicle (10) without increasing the wheelbase (FIGS. 3-9). The leg (38) includes the steering knuckle (110) the depending shaft/sleeve assembly (114) pivotably coupled thereto and the turning assembly (116) that includes a hydraulic cylinder (118) to pivot the shaft within the sleeve to turn the wheel (30) coupled to the shaft. The hydraulic cylinder (118) is coupled to the hydraulic pump (16) in a manner such as that known in the art.

By providing the turning assembly (116) between the suspension and the wheel, complicated prior art steering system linkage assemblies can be eliminated. Additionally, by providing the turning assembly (116) below the suspension, steering tolerances are tighter making the vehicle (10) easier to manage and allowing auto-steer systems to function more efficiently. Using the four-bar linkage described above allows a smaller hydraulic cylinder to lift the vehicle (10) a greater distance. In the preferred embodiment, the hydraulic cylinder is preferably a 61-centimeter hydraulic cylinder, which lifts the vehicle (10) 122 centimeters. Alternatively, any desired length of cylinders may be used from below 10 centimeters to in excess of 2 meters in length, depending on the application. Similarly, while in the preferred embodiment, the length of the cylinder to the lift height of the vehicle is 1 to 2, the angles and connection points of the four-bar linkage (28) may be modified to create a lift ratio anywhere from above 1 to 1, to 1 to 3 or more. The four-bar linkage assembly of the present invention also allows for four-wheel independent suspension and a large under vehicle clearance that eliminates axles spanning the complete width of the vehicle. While the linkages of the four-bar linkage (28) in the preferred embodiment are steel, they may be constructed of any desired dimensions or material.

When it is desired to operate the vehicle (10) of the preferred embodiment, the user (20) manipulates the control panel (22) to direct hydraulic fluid from the hydraulic pump (16) to the hydraulic cylinders (90). The hydraulic cylinders (90) push the ends of the sixth linkages (94) away from the main braces (40), causing the fourth linkages to rotate around the main braces (40). This pushes the fourth linkages (62) downward in a straight line, thereby raising the vehicle (10) without changing the length of the wheelbase of the vehicle (10). When it is desired to lower the vehicle (10), the user (20) manipulates the control panel (22) to return hydraulic fluid from the hydraulic cylinders (90), thereby contracting the hydraulic cylinders (90), drawing the ends of the sixth linkages (94) toward the main brace (40) and rotating the fourth linkages (62) in the opposite direction. This draws the fifth linkages (70) upward, lowering the vehicle (10) without changing the length of the wheelbase (120).

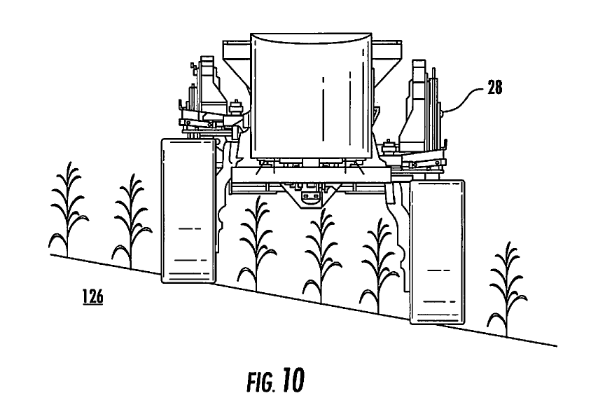

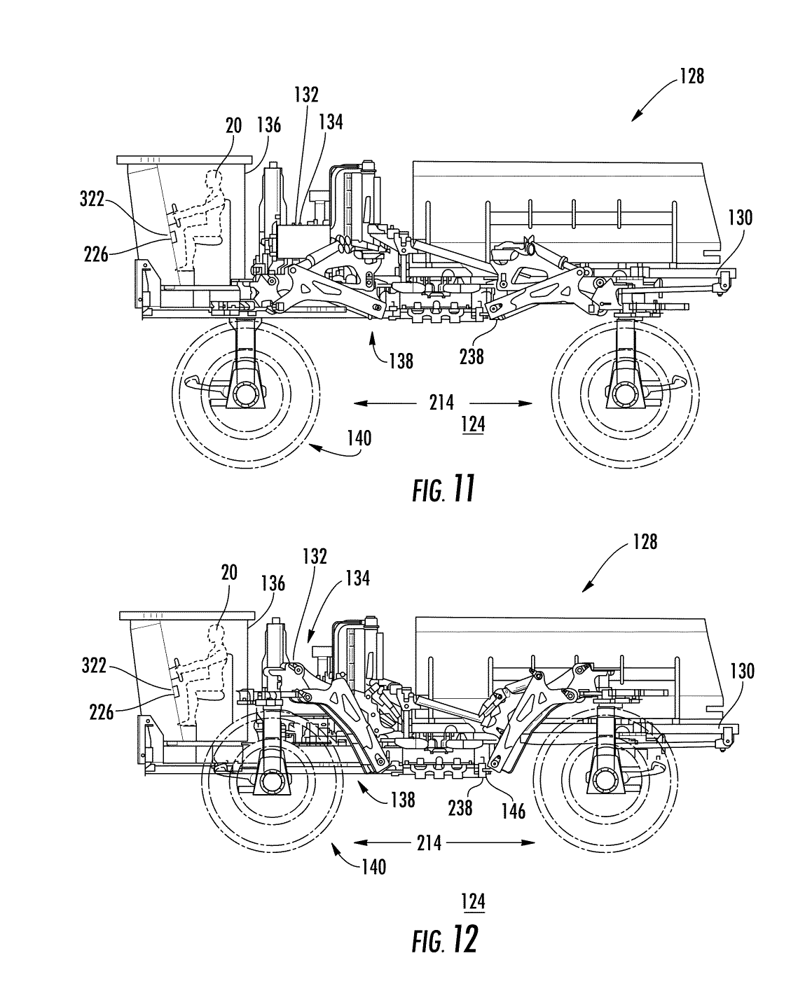

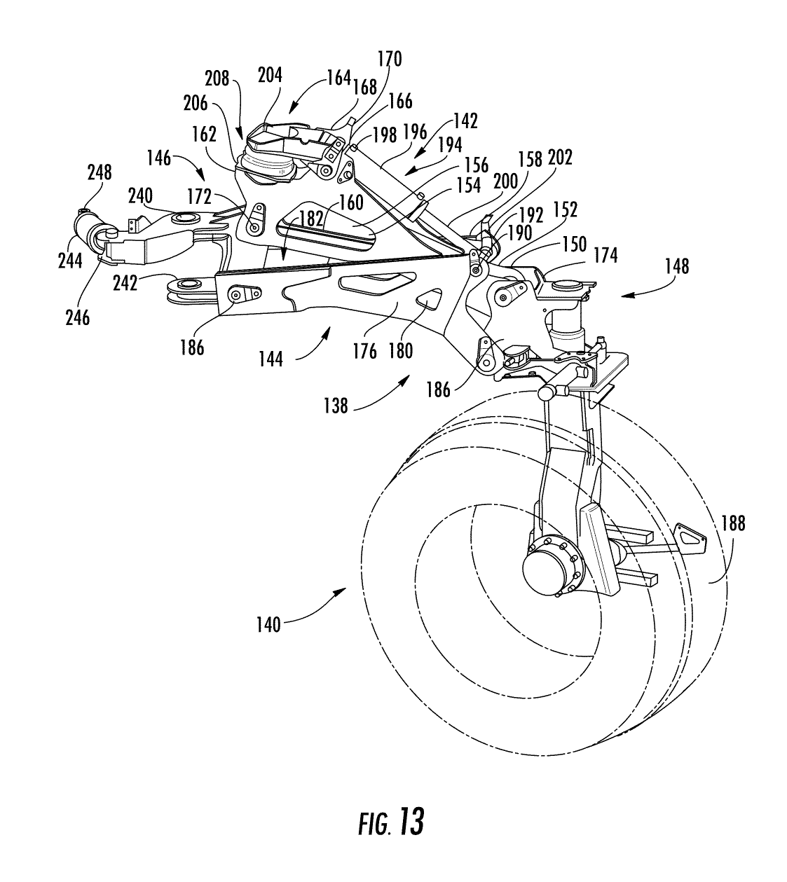

As shown in FIG. 1, the vehicle (10) may also be provided with an electronic control unit (ECU) (122) such as those known in the art. The electronic control unit (122) may be coupled to various other systems such as global positioning satellites, gyroscopic, or laser systems to monitor the ground (124). The ECU (122) may be programmed to maintain the vehicle (10) level even when the vehicle (10) is moving across uneven terrain (126) in a manner such as that shown in FIG. 10. As shown, either the user (20) or the Electronic Control Unit (122) may extend the four-bar linkage assemblies (28) on one side of the vehicle (10) and retract the four-bar linkage assemblies (28) on the opposite side of the vehicle (10) to allow the vehicle (10) to move along a slope while maintaining the vehicle (10) level. This type of maneuver is especially advantageous for vehicles carrying a large shifting weight and/or vehicles with a high center of gravity.

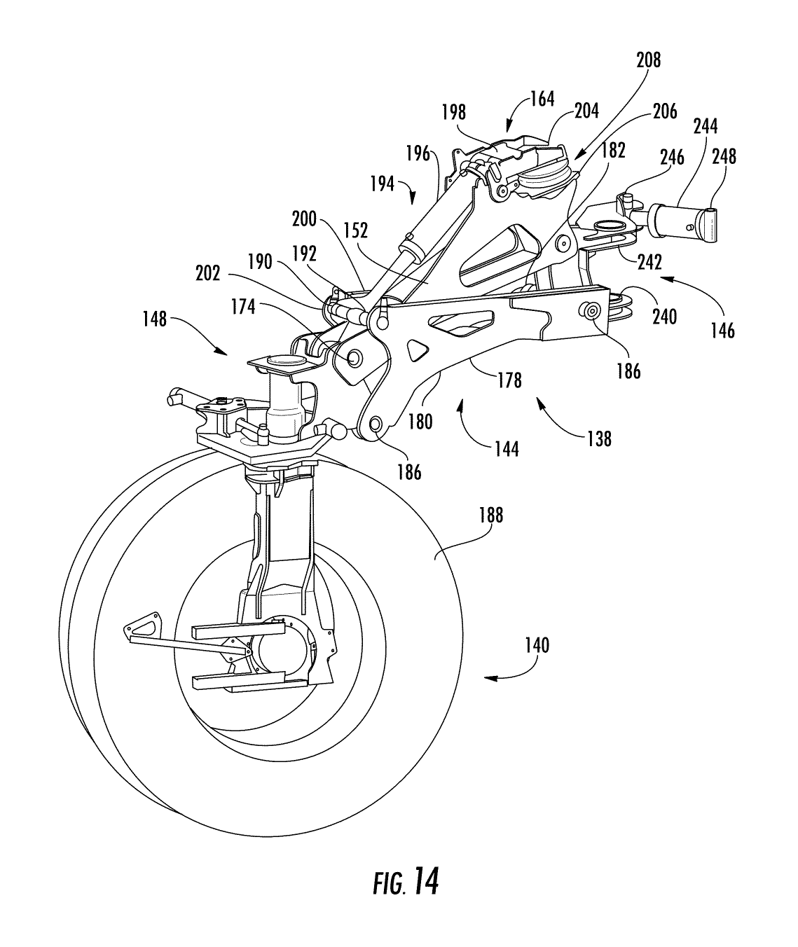

An alternative embodiment of the variable height vehicle is shown generally as (128) in FIG. 11. The vehicle (128) is provided with a frame (130) coupled to an engine (132) a hydraulic pump (134) and an operator station (136) as in the above embodiment, the vehicle (128) is lifted and lowered by a plurality of closed chain linkages, which are preferably four bar linkage assemblies (138). Separate four bar linkage assemblies (138) are provided for each wheel (140) of the vehicle (128). As the four bar linkage assemblies (138) are similar, except for being mirror images of one another, description will be limited to a single four bar linkage assembly (138).

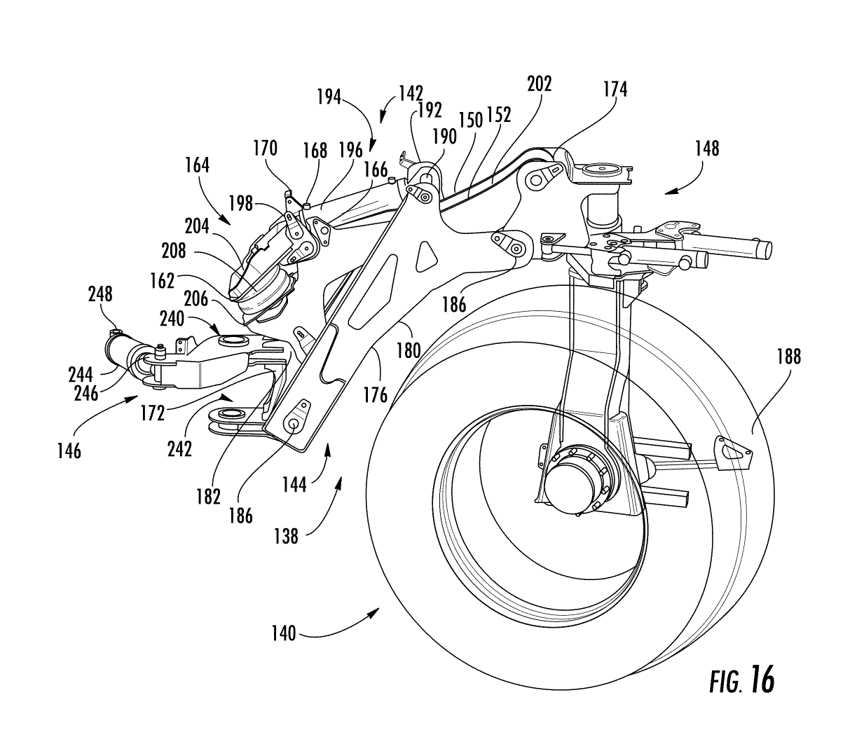

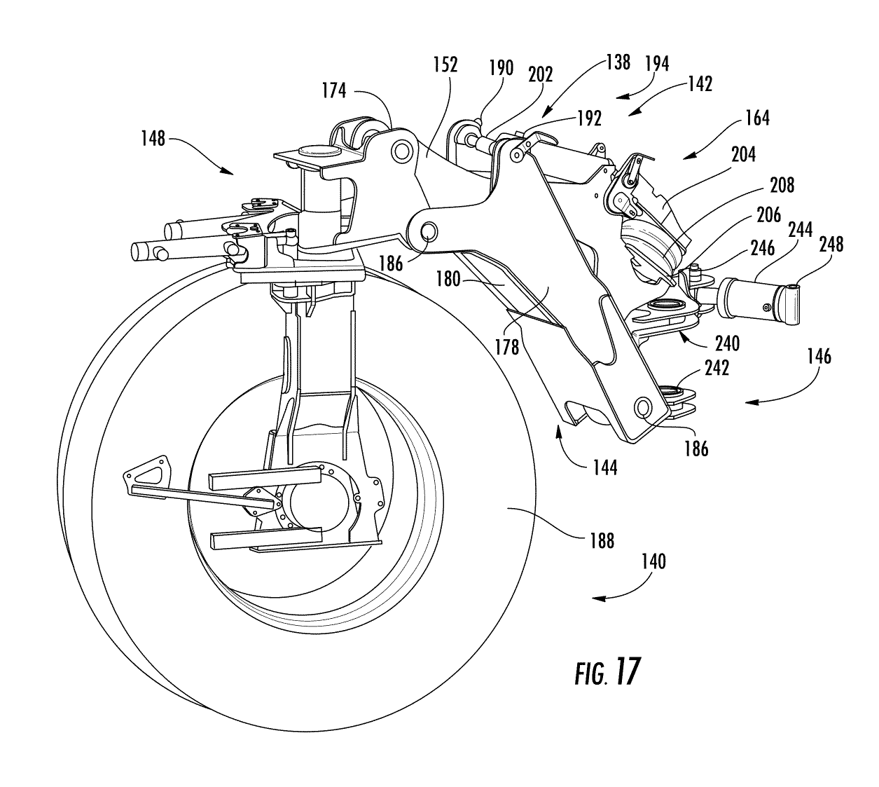

As shown in FIGS. 13-15, the four bar linkage assembly (138) is a closed chain linkage having a first arm (142) and a second arm (144). The remaining linkages in the four bar linkage assembly (138) are the frame bracket (146) and leg bracket (148). As shown in FIGS. 13-15, the first arm (142) has two generally triangular side plates (150 & 152) having triangular cutouts (154 & 156). The side plates (150 & 152) are each welded to a top steel plate (158) a bottom steel plate (160) and a back steel plate (162). The top steel plate (158) is welded to the side plates (150 & 152). A suspension conductor, such as a pivotable plate (164) is pivotably coupled to the side plates (150 & 152) of the first arm (142) by a pin (166). The pivotable plate (164) defines a pair of ears (168 & 170) that extend beyond the top steel plate (158). The first arm (142) is pivotably secured on either side of the frame bracket (146) by a pin (172) passing through the side plates (150 & 152) and the frame bracket (146). The first arm (142) is pivotably secured on its opposite end to the leg bracket (148). The side plates (150 & 152) of the first arm (142) are provided on the interior of the leg bracket (148) and pivotably secured thereto by a pin (174).

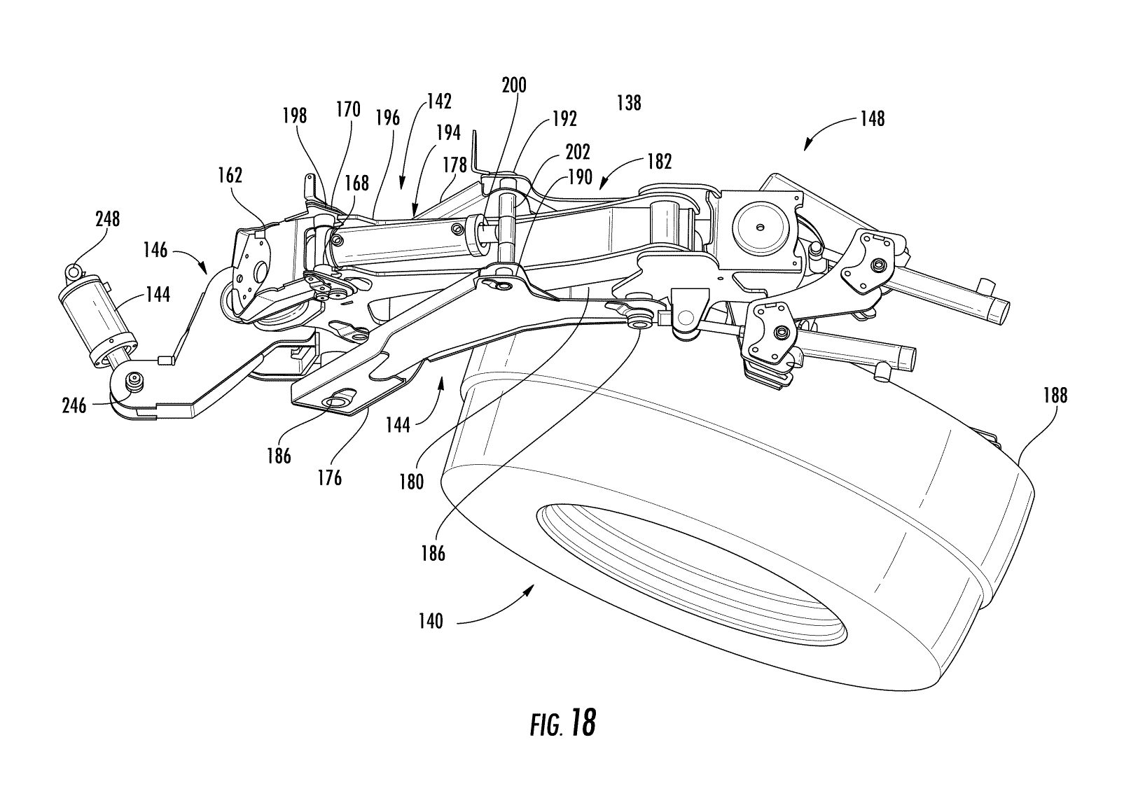

The second arm (144) is also provided with two side plates (176 & 178) constructed of steel and each welded to a bottom plate (180) to define an interior (182). The frame bracket (146) is provided within this interior (178) and pivotably secured to the side plates (176 & 178) by a pin (184). Similarly, the leg bracket (148) is also provided within this interior (178) of the second arm (144) and secured thereto by a pin (186). As shown in FIG. 16 the second arm (144) is preferably sufficiently curved to allow clearance for the tire (188) when the vehicle (10) is in the lowered position. The second arm (144) is preferably sufficiently curved so that at least one point along a straight line between the pins (184 & 186) is unobstructed by the second arm (144).

As shown in FIG. 13, the side plates (176 & 178) define ears (190 & 192) that extend above the first arm (142). A linear actuator (194), which in the preferred embodiment is a hydraulic cylinder, is coupled between the pivotable plate (164) and second arm (144). The barrel end (196) of the linear actuator (194) is pivotably coupled to the ears (168 & 170) of the pivotable plate (164) by a pin (198). The rod end (200) of the linear actuator (194) is pivotably coupled to the ears (190 & 192) of the second arm (144) by a pin (202) located above the first arm (142). The pivotable plate (164) defines a flat steel plate (204). A steel airbag receiver plate (206) is welded or otherwise secured to the first arm (142) and an airbag (208), such as those known in the art, is secured between the flat steel plate (204) of the pivotable plate (164) and the airbag receiver plate (206). The airbag (208) may be any fluid-filled resilient container, but is preferably an airspring with an elastomeric bellows constructed from rubber reinforced with two plies of cord fabric and having round metal plate end closures such as a Firestone® Airmount Actuator 233-2 style bellows, distributed by Firestone Industrial Products Company. The airbag (208) isolates and dampens vibration between the first arm (142) and the second arm (144) as the vehicle (128) starts or stops, or moves over uneven terrain (210). As shown, the pin (202) and top portion of the ears (190 & 192) remain above the first arm (142) as the first arm (142) and the second arm (144) move in relation to one another.

Preferably, the airbag (208) is coupled to the linear actuator (194) to provide suspension for the vehicle (128). The linear actuator (194) is provided with an accumulator in a manner such as that known in the art to allow the linear actuator (194) to isolate and dampens vibration between the first arm (142) and the second arm (144) as the vehicle (128) starts or stops, or moves over uneven terrain (210). The airbag (208) and linear actuator (194) are coupled to each other by opposite ends of the pivotable plate (164), which is connected to, and seesaws relative to, the first arm (142). As shown in FIG. 13, the pivotable plate (164) is pivotably coupled at a pivot point to and anchor, such as the first arm (142). The first end, or flat steel plate (204) end, of the pivotable plate (164) is coupled to the airbag (208), while the second end, or ears (168 & 170) end, of the pivotable plate (164) is pivotably coupled to the linear actuator (194). As the vehicle (128) moves, both the airbag (208) and linear actuator (194) act against the seesawing pivotable plate (164) to absorb vibration transfer between the first arm (142) and the second arm (144). Alternatively, if desired, the pivotable plate (164), steel airbag receiver plate (206), and airbag (208) may be eliminated and the linear actuator (194) may be coupled directly between the first arm (142) and the second arm (144). In this embodiment, the suspension may be eliminated, or a prior art suspension system, such as providing the linear actuator (194) with an accumulator, such as those known on the art, may allow the linear actuator (194) to be used for suspension.

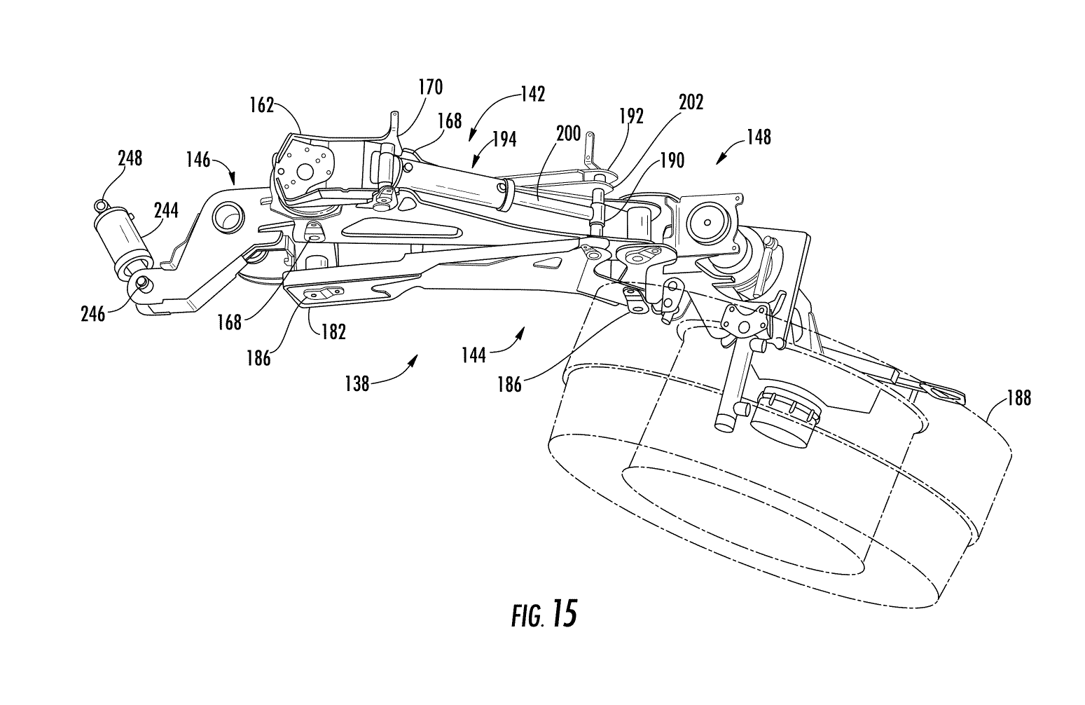

When it is desired to operate the vehicle (128), the user (20) manipulates a control panel (226) to direct hydraulic fluid from the hydraulic pump (134) to the linear actuator (194). (FIGS. 11-14). The linear actuator (194) pushes the rod end (200) away from the barrel (196) thereby moving the ears (190 & 192) of the second arm (144) away from the ears (168 & 170) of the pivotable plate (164) of the first arm (142). As shown in FIG. 13, this causes the second arm (144) to rotate clockwise, lifting the frame bracket (146) relative to the leg bracket (148), and thereby lifting the frame (130) above the ground (124). As shown in FIGS. 11 & 12, raising the frame (130) of the vehicle (128) relative to the ground (124) also increases the size of the wheelbase (214) of the vehicle (128). When it is desired to lower the vehicle (128) the user (20) manipulates the control panel (226) to return hydraulic fluid from the linear actuator (194), thereby drawing the ears (190 & 192) of the second arm (144) toward the ears (168 & 170) of the pivotable plate (164). This causes the second arm (144) to rotate in a counter-clockwise direction, lowering the vehicle (128) while reducing the length of the wheelbase (214). While the linear actuator (194) may be used alone to control the suspension of the vehicle (128) using a “float” mode in a manner such as those known in the art, in the preferred embodiment the airbag (208) is used for suspension in addition to the float of the linear actuator (194). Alternatively, the hydraulic cylinder (194) may be locked in place to maintain a gross height of the vehicle (128) while the airbag (208) controls the suspension of the vehicle (128).

As shown in FIG. 13, a steering assembly (228) is coupled to the leg bracket (148) to allow the user (20) to steer the vehicle (128) independently of the four bar linkage assembly (138) and the suspension of the vehicle (128). While the four bar linkage assembly (138) may be provided in any desired configuration, in the preferred embodiment the first arm (142) is coupled to the frame bracket (146) at a point higher than the point at which the second arm (144) is coupled to the frame bracket (146). Similarly, the first arm (142) is coupled to the leg bracket (148) at a point above the point at which the second arm (144) is coupled to the leg bracket (148).

While the vehicle (128) and four bar linkage assembly (138) may be provided with any desired dimensions, in the preferred embodiment the four bar linkage assembly (138) is designed to change the ground clearance of the frame (130) from 107 cm to 244 cm, allowing for a height change of 137 cm. The four bar linkage assembly (138) is preferably designed to change the ground clearance of the frame (130) at least 50 cm, more preferably at least 80 cm and most preferably at least 100 cm. Preferably the four bar linkage assembly (138) is designed to at least double the ground clearance of the frame (130). As shown in FIGS. 11 & 12, the front and rear linkage assemblies (138) are preferably provided along the same plane in mirrored orientation relative to one another. If desired, the linkage assemblies (138) may be oriented in a non-planar orientation. The two front linkage assemblies (138) are preferably provided on opposite sides of the frame (130) in a mirror orientation relative to one another. The two rear linkage assemblies (138) are also preferably provided on opposite sides of the frame (130) in a mirror orientation relative to one another. If desired however, the linkage assemblies (138) may be oriented in a non-planar orientation and/or staggered orientation relative to one another.

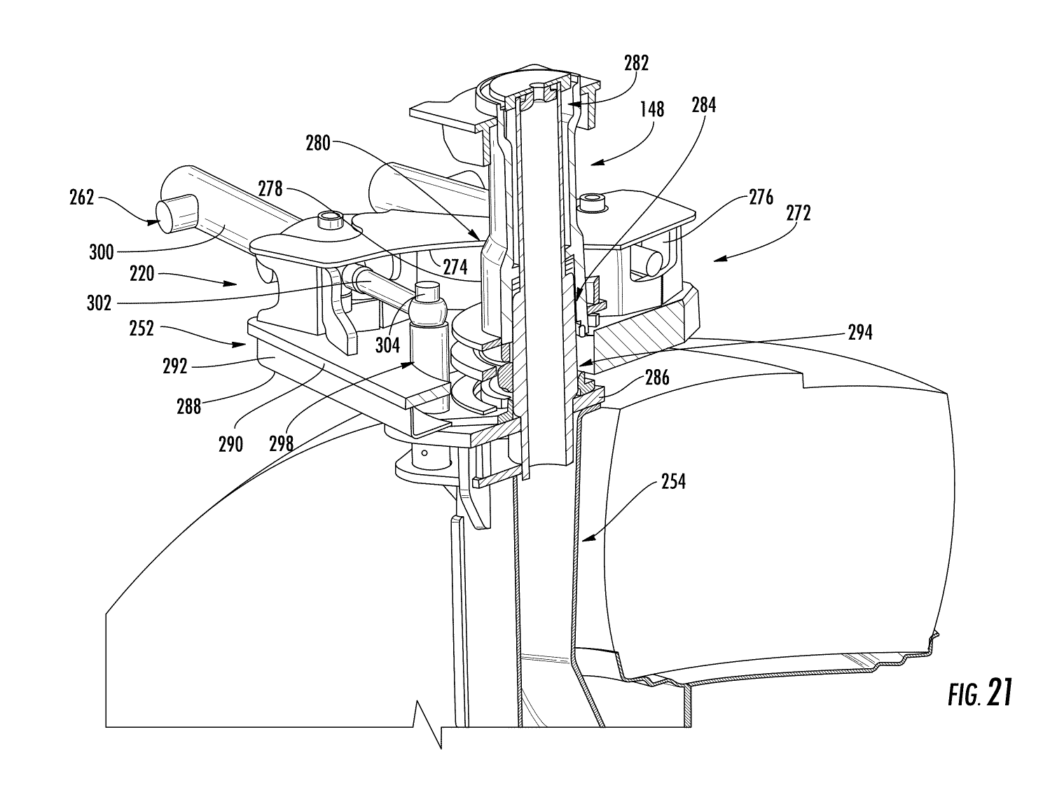

As shown in FIG. 19, the four bar linkage assemblies (138) may be operated independently to allow the vehicle (128) to follow the contour of the uneven terrain (210) while maintaining the frame (130) level. As shown in FIG. 19, the linkage assemblies (138) are oriented in a manner such that even when traversing uneven terrain (210) a line drawn from the midline (216) of the left rear wheel (218) to a midline (220) of the right rear wheel (222) is unobstructed to allow for the passage of crops (224) underneath.

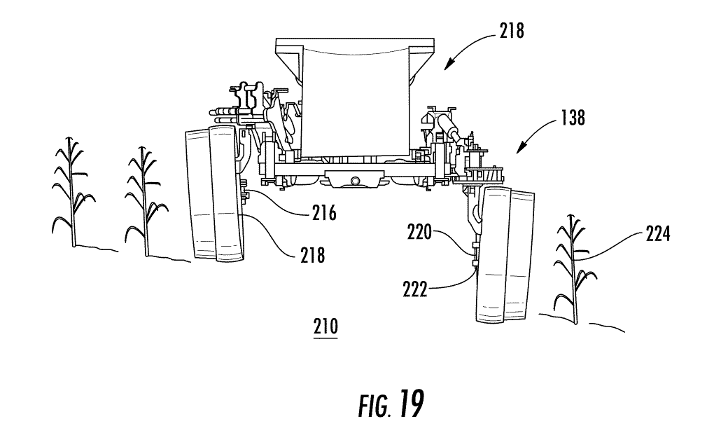

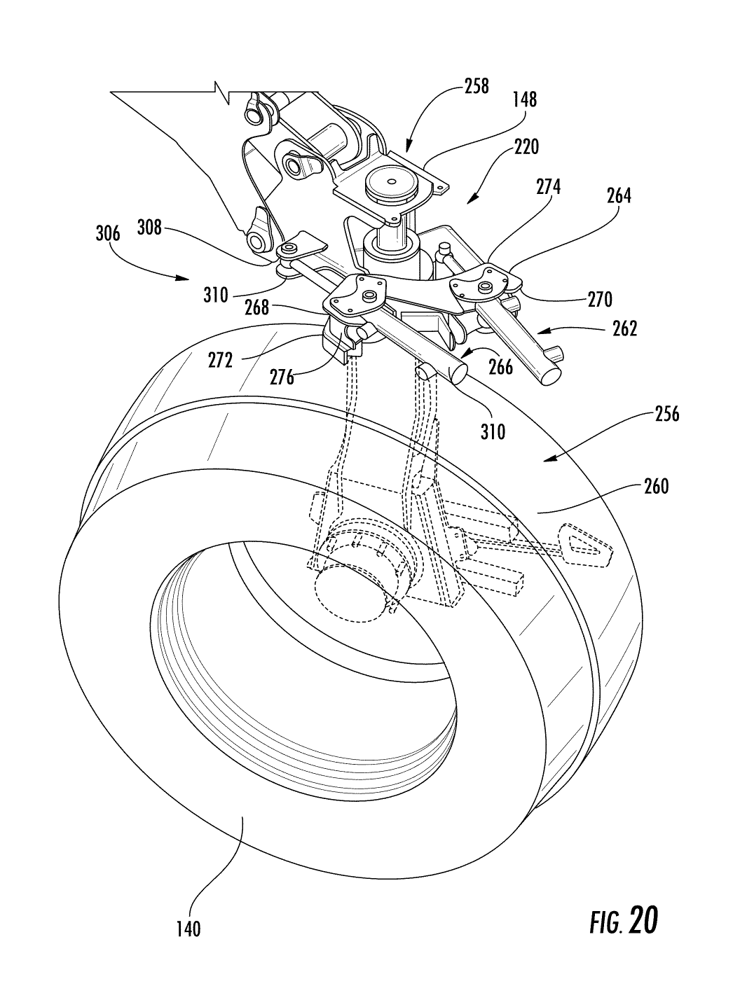

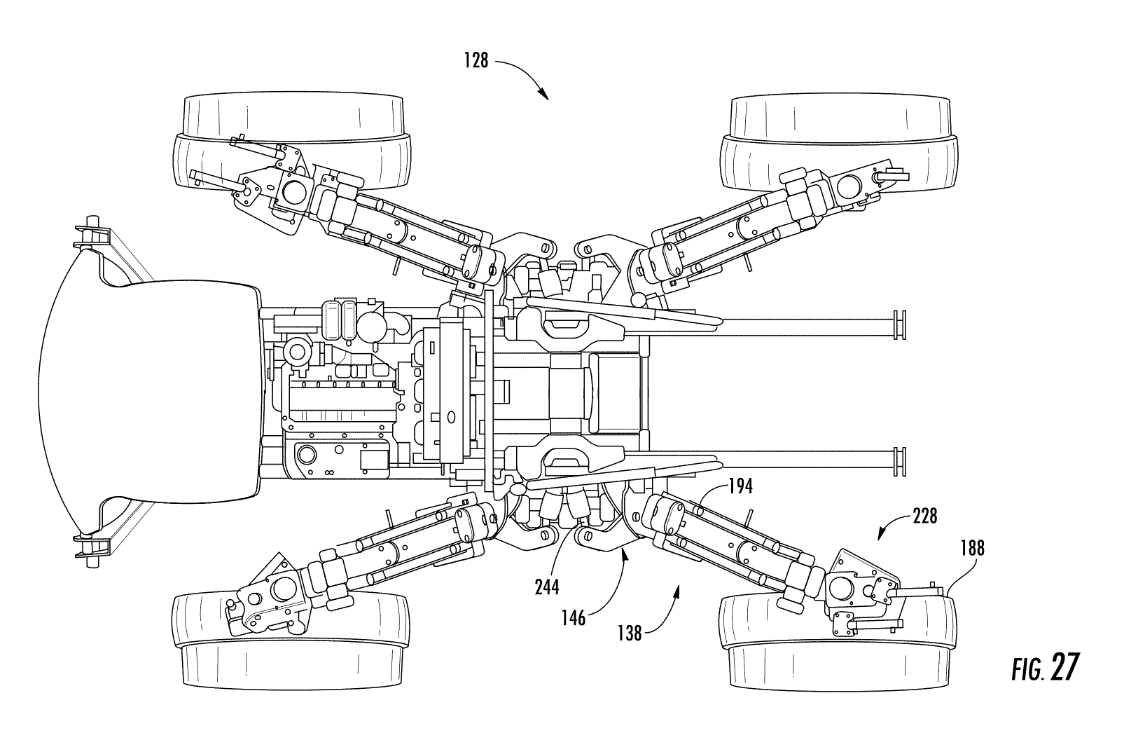

As shown in FIGS. 11-18, four bar linkage assembly (138) is pivotably coupled to the frame (130) of the vehicle (128) by a pin (238) passing through two holes (240 & 242) in the frame bracket (146) and a hole (not shown) in a portion of the frame (130) provided between the holes (240 & 242). A journal actuator such as a hydraulic cylinder (244) is pivotably coupled to both the frame bracket (146) and frame (130) by a pair of pins (246 & 248). As explained in more detail below, as the hydraulic cylinder (244) is actuated, the four bar linkage assembly (138) pivots relative to the frame (130) moving the wheel (140) alternately closer and further away from the frame (130) changing the tread width (250) of the vehicle (128). (FIGS. 11-18 and 26-27).

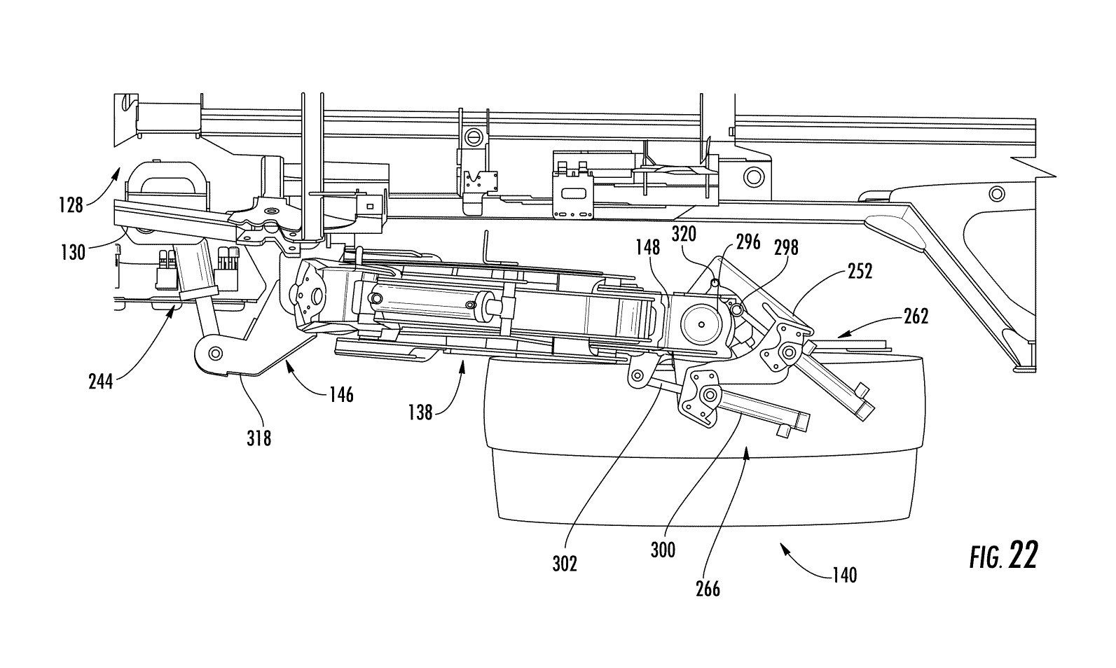

As shown in FIG. 20, the turning assembly (220) has a connector such as a steering plate (252) that is provided around a leg (254) of the vehicle (128) like a sleeve, with freedom to move vertically relative to the sleeve. The leg (254) has a first end (256) and a second end (258). The first end of the leg (256) is journaled to the wheel (140) a hydraulic motor (260) is provided on the first end (256) of the leg (254) to drive the wheel (140) in a manner such as that known in the art. A linear actuator such as a hydraulic cylinder (262) is pivotably secured to the steering plate (252) by a trunion (264). A second actuator such as a hydraulic cylinder (266) is also pivotably secured to the steering plate (252) by trunion (268). As shown in FIG. 21 two steel housing assemblies (270 & 272) are welded or otherwise secured to the steering plate (252). A steel bracket (274) is belted or otherwise secured to the tops of both housing assemblies (270 & 272). Provided within the housing assembly (270) is hydraulic cylinder (262) pivotably coupled by the trunion (264) to both the steering plate (252) and bracket (274). Similarly, provided within the housing assembly (272) is a hydraulic cylinder (266) pivotably coupled by the trunion (268) to both the steering plate (252) and bracket (274). The housing assemblies (270 & 272) are provided with openings (276) on both the front and back to allow the hydraulic cylinders (262 & 266) to extend therethrough. The openings (276) are preferably wide enough to accommodate the hydraulic cylinders (262 & 266) through their full ranges of motion.

As shown in FIG. 21 the leg (254) defines a ledge (278) upon which is provided an axial thrust bearing (280). Resting on top of the axial thrust bearing (280) is the leg bracket (148). Also provided between the second end (258) of the leg (254) and the leg bracket (148) are a pair of radial bearings (282 & 284) that allow the leg (254) to rotate relative to the leg bracket (148). The axial thrust bearing (280) bears the majority of the downward pressure of leg bracket (148) on the ledge (278) of the leg (254) allowing the radial bearings (282 & 284) to rotate more freely.

The leg (254) is also provided with a shelf (286) on which rests the steering plate (252). The steering plate (252) as shown has a bottom steel plate (288) and a top steel plate (290) connected to one another by one or more side plates (292). The steering plate (252) may be formed from a single sheet of stamped steel or may be a plurality of parts welded together. Provided between the bottom steel plate (288) and the top steel plate (290) is a radial bearing (294) provided around the leg (254) in a manner that allows the steering plate (252) to freely rotate around the leg (254). The steering plate (252) is provided with a cutout (296) to accommodate a steel bar (298) bolted, welded or otherwise secured to the shelf (286). The cutout (296) is preferably configured to accommodate the steel bar (298) across the full range of the steering plates (252) motion. Whereas the barrel (300) of the hydraulic cylinder (262) is pivotably coupled to the housing assembly (270) by the trunion (264), the rod, (302) of the hydraulic cylinder (262) is pivotably coupled to the steel bar (298) by a pin (304) passing through the rod (302).

As shown in FIG. 20, the leg bracket (148) is provided with an ear (306). The ear (306) has a top steel plate (308) and bottom steel plate (310) welded or otherwise secured to the leg bracket (148). While the barrel (312) of the hydraulic cylinder (266) is pivotably coupled to the housing assembly (272) by the trunion (268), the rod (214) of the hydraulic cylinder (266) is pivotably coupled to the leg bracket (148) by a pin (316) coupled to the stop steel plate (308) and bottom steel plate (310) and passing through the rod (314).

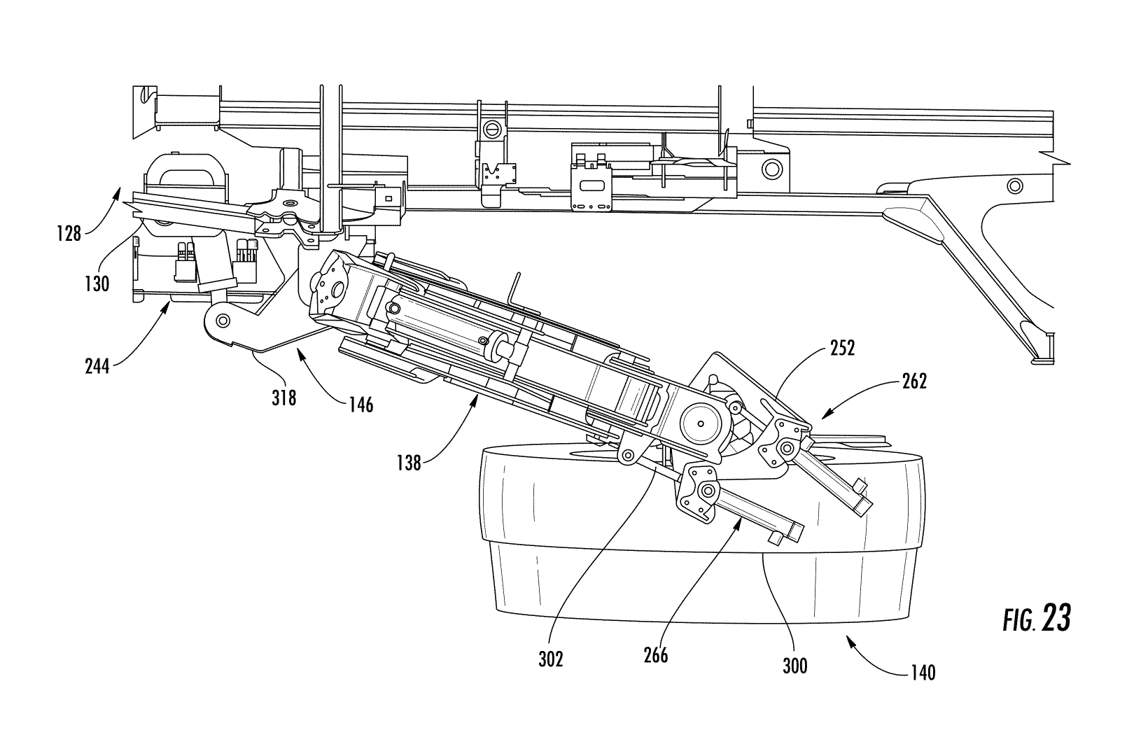

As shown in FIG. 22, when it is desired to provide the vehicle (128) with the minimum tread width (250), user (20) uses the control panel (226) to extend the hydraulic cylinder (244) moving the cantilevered arm (318) of the frame bracket (146) away from the frame (130) of the vehicle (128) thereby drawing the wheel (140) closer to the frame (130). Once the user (20) has performed this operation for all four linkage assemblies (138) the vehicle (128) will have a smaller tread width (250). FIGS. 19 & 22. While it would be possible to steer the wheels (140) with a single cylinder, such a single cylinder would provide a different turn radius for the vehicle (128) when the wheels (140) are refracted toward the frame (130) and when the wheels (140) are provided at their maximum tread width. To address this discrepancy, the vehicle (128) is provided with the hydraulic cylinder (266) to adjust for toe compensation when the wheels (140) are moved between tread widths. As shown in FIG. 22, when the wheel (140) is drawn toward the frame (130) reducing the tread width (250), the hydraulic cylinder (266) is actuated to retract the rod (302) into the barrel (300) of the hydraulic cylinder (266). This action causes the steering plate (252) to rotate relative to the leg bracket (148) repositioning the hydraulic cylinder (262) and the cutout (296) to allow the hydraulic cylinder (262) a full range of motion to provide the vehicle (128) to provide the vehicle (128) with the desired turning radius. As shown, the ends of the cutout (296) are provided with stops (320) to prevent the steel bar (298) from damaging the steering plate (252) in the event the hydraulic cylinder (262) tries to over rotate the steering plate (252).

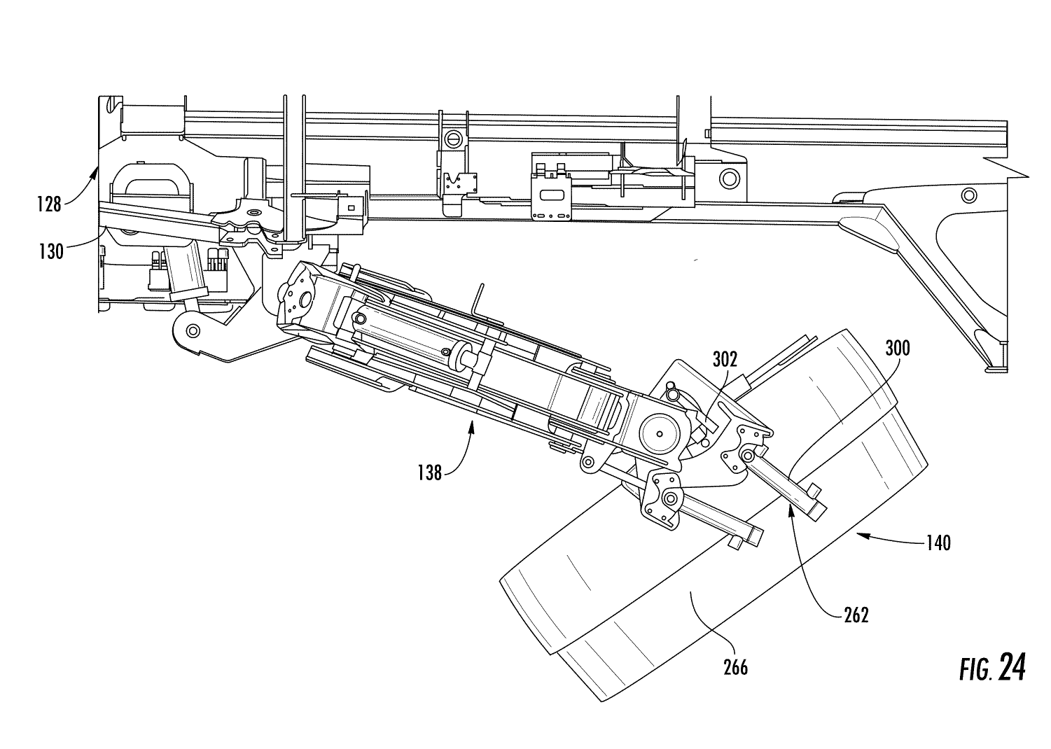

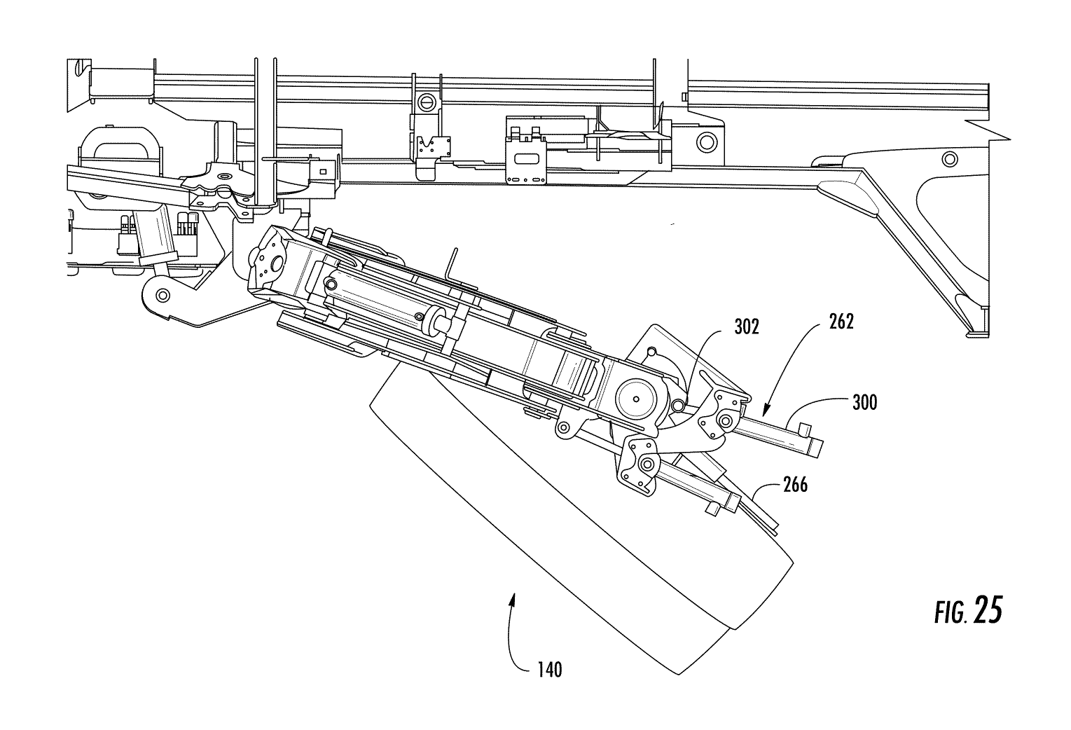

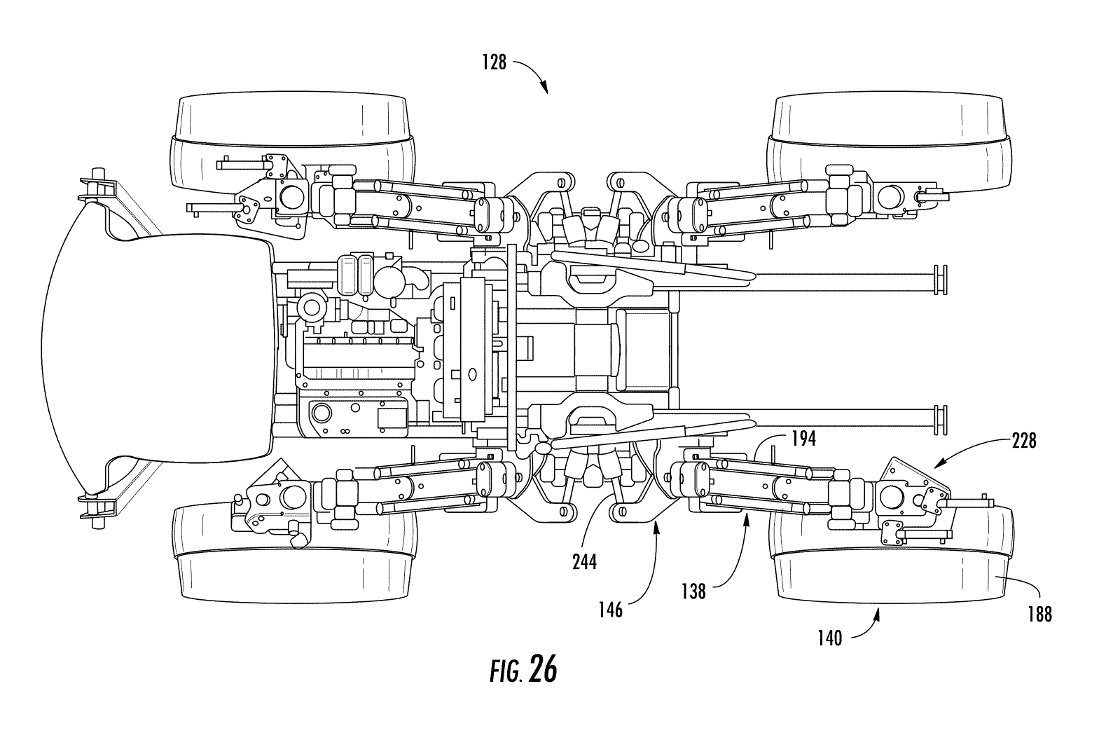

While the movement of the cylinder (244) and cylinder (266) may be actuated individually by the user (20), in the preferred embodiment, the control panel (226) is provided with a central processing unit (322) that automatically actuates the cylinder (266) in response to movement of the cylinder (244) to properly readjust the toe as the tread width changes. While the vehicle (128) may be provided with any desired range of tread width adjustability, in the preferred embodiment the vehicle (128) is capable adjusting the angle of the four bar linkage (138) relative the frame (130) preferably between 0° and 90°, more preferably between 0° and 45° and most preferably between about 5° as shown in FIG. 22 and 20° as shown in FIG. 23. As shown in FIG. 23, when it is desired to increase the tread width (250) of the vehicle (128) the user (20) actuates the control panel (226) to retract the cylinder (244) pivoting the cantilevered arm (318) of the frame bracket (146) toward the frame (130) of the vehicle (128) and pivoting the four bar linkage (138) away from the frame (130) of the vehicle (128). FIGS. 11, 19 and 23. As the hydraulic cylinder (244) retracts, the central processing unit (322) automatically causes the hydraulic cylinder (266) to extend the rod (302) relative to the barrel (300) thereby rotating the steering plate (252) to allow the hydraulic cylinder (266) to maintain its full range of motion. Once the tread width (250) has been extended using the cylinder (244), and the toe automatically adjusted by the hydraulic cylinder (266), the user (20) can use a steering controller such as a steering wheel (324) to steer the wheels (140) across the full desired range of motion. This range of motion is shown in FIGS. 24 & 25. As shown in FIG. 24, when the user (20) turns the steering wheel (324) all the way to the right, this causes the hydraulic cylinder (262) to retract the rod (302) into the barrel (300) thereby turning the wheel (140) the maximum desired amount to the right. Conversely, as shown in FIG. 25, when it is desired to turn the wheel (140) to the left, the user (20) turns the steering wheel (324) to the left which causes the hydraulic cylinder (262) to extend the rod (302) from the barrel (300) thereby turning the wheel (140) the maximum desired amount to the left. Without the provision of the hydraulic cylinder (266), when the four bar linkage (138) was rotated away from the frame (130) of the vehicle (128), the toe of the wheel (140) would be too far to the right thereby dramatically and undesirably limiting the ability of the hydraulic cylinder (262) to steer the wheel (140) to the left. Exacerbating the problem is that the wheel (140) on the opposite side of the vehicle (128) without the hydraulic cylinder (266) to compensate for the toe of the wheel (140), the toe of the wheel (140) would be too far to the left so that the wheels (140) would no longer be parallel. While the cylinder (262) could conceivably be independently operated to align the wheels (140) parallel to one another because the right wheel would have a limited range of motion turning to the left and the left wheel (140) would have a limited range of motion turning to the right, the overall turning radius of the vehicle (128) would be dramatically and undesirably limited. By providing the cylinder 266 to automatically adjust the toe of the wheels (140), there is no need to independently operate the hydraulic cylinders (262) controlling the steering. The hydraulic cylinders (266) maintain the wheels (140) parallel to one another regardless as to whether the tread width of the vehicle (128) is at its maximum or minimum.

Although the invention has been described with respect to a preferred embodiment thereof, it is to be understood that it is not to be so limited since changes and modifications can be made therein which are in within the full, intended scope of this invention as defined by the appended claims.

What is claimed is:

1. A vehicle comprising
(a) a frame;
(b) a leg
(d) a wheel coupled to the leg;
(e) a suspension assembly coupling the leg to the frame, wherein the suspension assembly comprises:
(i) an airbag; and
(ii) a linear actuator coupled to the airbag in a manner in which both the airbag and linear actuator allow relative motion between the frame and the leg.

2. The vehicle of claim 1, wherein linear actuator comprises an accumulator.

3. The vehicle of claim 1, further comprising a suspension conductor coupled between the airbag and the linear actuator.

4. The vehicle of claim 3, wherein the suspension conductor is pivotably coupled to the linear actuator.

5. The vehicle of claim 3, wherein the suspension conductor comprises:
(a) a first end coupled to the airbag;
(b) a second end coupled to the linear actuator; and
(c) a pivot point; and
(d) an anchor pivotably coupled to the pivot point.

6. The vehicle of claim 5, wherein the pivot point is located between the first end and the second end.

7. The vehicle of claim 3, wherein the suspension conductor comprises a plate coupled to the airbag.

8. The vehicle of claim 1, further comprising a closed chain linkage assembly comprising:
(a) a first linkage assembly pivotably coupled between the leg and the frame;
(b) a second linkage assembly pivotably coupled between the leg and the frame;
(c) a third linkage coupled between the first linkage and the second linkage; and
(d) a fourth linkage coupled between the first linkage and the second linkage.

9. The vehicle of claim 8, further comprising a suspension conductor coupled between the airbag and the linear actuator.

10. The vehicle of claim 9, wherein the suspension conductor is pivotably coupled to the linear actuator.

11. The vehicle of claim 9, wherein the suspension conductor comprises:
(a) a first end coupled to the airbag;
(b) a second end coupled to the linear actuator; and
(c) a pivot point pivotably coupled to the first linkage.

12. The vehicle of claim 5, wherein the pivot point is located between the first end and the second end.

13. The vehicle of claim 9, wherein the suspension conductor comprises a plate coupled to the airbag.

14. The vehicle of claim 1, wherein linear actuator is adjustable between a first position that maintains the vehicle at a first ground clearance and a second position that maintains the vehicle at a second ground clearance, and wherein the second ground clearance is at least fifty centimeters higher than the first ground clearance.

15. A vehicle comprising
(a) a frame;
(b) a leg
(d) a wheel coupled to the leg;
(e) a closed chain linkage assembly comprising:
(i) a first linkage assembly pivotably coupled between the leg and the frame;
(ii) a second linkage assembly pivotably coupled between the leg and the frame;
(iii) a third linkage coupled between the first linkage and the second linkage; and
(iv) a fourth linkage coupled between the first linkage and the second linkage.
(f) a suspension assembly coupled to the first linkage, wherein the suspension assembly comprises:
(i) an airbag coupled to the first linkage; and
(ii) a linear actuator coupled between the airbag and the second linkage in a manner in which both the airbag and linear actuator allow relative motion between the frame and the leg.

16. The vehicle of claim 15, further comprising a suspension conductor coupled between the airbag and the linear actuator.

17. The vehicle of claim 16, wherein the suspension conductor is pivotably coupled to the linear actuator.

18. The vehicle of claim 16, wherein the suspension conductor comprises:
(a) a first end coupled to the airbag;
(b) a second end coupled to the linear actuator; and
(c) a pivot point pivotably coupled to the first linkage.

19. The vehicle of claim 15, wherein linear actuator is adjustable between a first position that maintains the vehicle at a first ground clearance and a second position that maintains the vehicle at a second ground clearance, and wherein the second ground clearance is at least fifty centimeters higher than the first ground clearance.

20. A adjustable height vehicle comprising
(a) a frame;
(b) a leg
(d) a wheel coupled to the leg;
(e) a closed chain linkage lift assembly comprising:
(i) a first linkage assembly pivotably coupled between the leg and the frame;
(ii) a second linkage assembly pivotably coupled between the leg and the frame;
(iii) a third linkage coupled between the first linkage and the second linkage; and
(iv) a fourth linkage coupled between the first linkage and the second linkage.
(f) a suspension assembly coupled to the first linkage, wherein the suspension assembly comprises:
(i) an airbag coupled to the first linkage; and
(ii) a linear actuator coupled between the airbag and the second linkage in a manner in which both the airbag and linear actuator allow relative motion between the frame and that lifts the frame relative to the first wheel at least fifty centimeters when the first linear actuator is actuated in a first direction, and that lowers the frame relative to the first wheel at least fifty centimeters when the first linear actuator is actuated in a second direction.
